(19) United States
(12) Patent Application Publication
(10) Pub. No.: US 2015/0089356 A1
(43) Pub. Date: Mar. 26, 2015

(54) Text Selection

(71) Applicant: International Business Machines Corporation, Armonk, NY (US)

(72) Inventors: Aleksandrs Baklanovs, Winchester (GB); Daniel T. Fitzgerald, Winchester (GB); Joe L. Hartshorn, Portsmouth (GB); Rhys L. Short, Bristol (GB)

(21) Appl. No.: 14/497,030

(22) Filed: Sep. 25, 2014

(30) Foreign Application Priority Data
Sep. 26, 2013 (GB) 1317055.0

(51) Int. Cl. G06F 17/24; G06F 3/0481

(52) U.S. Cl. CPC G06F 17/24; G06F 3/0481
USPC 715/255

(57) ABSTRACT

Mechanisms for selecting text within a displayed document comprises mechanisms for performing the operations of displaying a document comprising continuous text, receiving user input defining a single continuous area of the displayed document, the defined area covering text within the displayed document that is non-continuous, and capturing the text within the defined area. Objects can also be selected with the tool, and multiple areas can also be selected in the same way, all of which can be of any shape that the user desires.

### BACKGROUND

This invention relates to a method of, computer program product for, and system for, selecting text within a displayed document.

In computing environments such as desktop computing, it is common to use word processing applications that allow a user to create and edit text documents. Many other applications also work in similar ways, such as HTML editors and development environments for writing computer code, where users enter text into an editor that is handled in much the same way as standard text. Within such applications, the selection of text is a well-known function. Current selection tools within existing applications such as Microsoft Windows™, Eclipse™ and SlickEdit™ allow text selection by specifying a beginning and end point through a mouse gesture or keyboard action. The user can then copy the selected text or make global changes to the selected text such as underlining the text. However, only continuous text can be selected in such applications, which places limits on the full usefulness of this function.

### SUMMARY

According to a first aspect of the illustrative embodiments, there is provided a method of selecting text within a displayed document, the method comprising the operations for displaying a document comprising continuous text, receiving user input defining a single continuous area of the displayed document, the defined area covering text within the displayed document that is non-continuous, and capturing the text within the defined area.

According to a second aspect of the illustrative embodiments, there is provided a system for selecting text within a displayed document, the system comprising a processor arranged to display a document comprising continuous text, receive user input defining a single continuous area of the displayed document, the defined area covering text within the displayed document that is non-continuous, and capture the text within the defined area.

According to a third aspect of the illustrative embodiments, there is provided a computer program product on a computer readable medium for selecting text within a displayed document, the product comprising instructions for displaying a document comprising continuous text, receiving user input defining a single continuous area of the displayed document, the defined area covering text within the displayed document that is non-continuous, and capturing the text within the defined area.

Owing to the mechanisms of the illustrative embodiments, a method is provided that will allow a user to select text that is not continuous in a displayed document, since the user can define an area that is of any shape of their choosing. The method not only allows the user to provide any shape for the selection area, but also allows the user to select objects (such as images) that are present in the current window, as well as the text. The method can be embodied as a standalone tool that can be run alongside other applications, or can be embedded within the specific application as an accessible function of the current application. The methodology will work both with static (e.g., web pages) and dynamic (e.g., text editor) text and objects, thereby allowing the user to select/delete/replace the selection in all types of applications that use text. A displayed document is the output of any kind of application that displays text that a user may wish to select.

The method allows free shape selection of text and objects on the screen, where the selection area can be smaller than the width of the text field. For example, the user can press a specified key on the keyboard, and while this key is pressed, click on the screen to define the edges of the area that the user wants selected. The user can also draw multiple shapes at the same time creating one or more selections that will be stored in memory and pasted together but in separate pieces. Based on user specified settings, the method can either paste the selection with the original formatting or without the formatting. The method can paste in the order the selections were made or in the order of their location on the screen.

The method selects the text and/or objects within the selected area and allows the user to copy (in a static document) or copy/replace/delete (in a dynamic document). The method can work both with static and dynamic text in applications, with different functionality levels, provided that the tool implementing the method is familiar with formatting procedures of these applications. The tool can be executed on its own and used with environments containing text and objects.

Preferably, the defined area of the displayed document is non-rectangular and the defined area of the displayed document is a simple irregular polygon with the received user input comprising the location of the points of the simple irregular polygon. In one illustrative embodiment, the user can define an area that comprises a series of connected straight lines, thereby forming a simple irregular polygon. The user can define a series of points and lines will be drawn to connect the points together. This allows a user to freely create a selection that will acquire text that is non-continuous within the displayed document.

Advantageously, the method further comprises receiving further user input defining a second single continuous area of the displayed document, the second defined area covering text within the displayed document that is non-continuous, and capturing the text within the second defined area. As mentioned above, the user can define multiple areas and these will be captured in turn, again with no restrictions on any of the areas so that multiple instances of non-continuous text can be captured. The shape of all of the areas selected will be under the user's control and will allow the user to continually select areas that define non-continuous text.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a schematic diagram of a computing system in which aspects of the illustrative embodiments may be implemented;

FIGS. 2 to 5 are screenshots of a displayed document illustrating an operation of one illustrative embodiment; and

FIG. 6 is a flowchart outlining an example operation for selecting text within a document in accordance with one illustrative embodiment.

### DETAILED DESCRIPTION

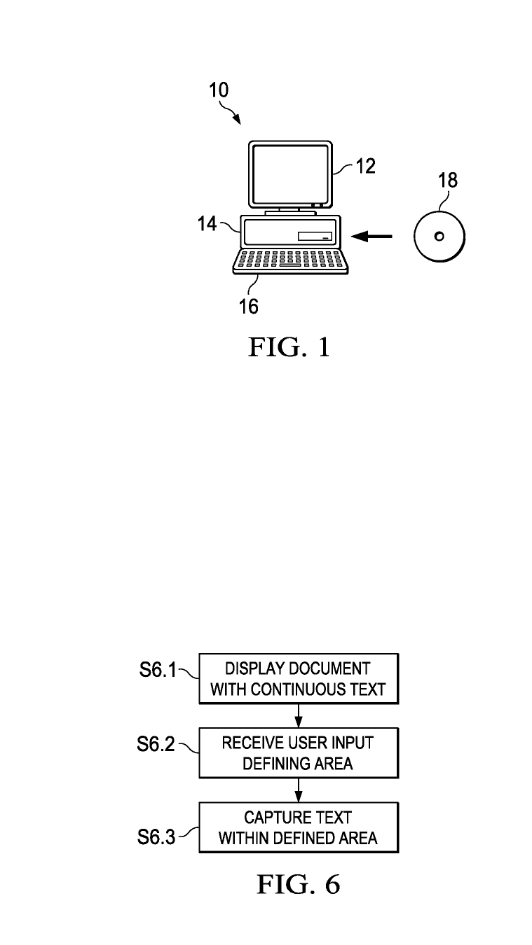

FIG. 1 shows a computing system 10, which comprises a display device 12, a processor 14 and a user interface 16. The processor 14 is connected to the display device 12 and the user interface 16. The user interface 16 is a keyboard and additional user interface devices may also be provided, such as a mouse, which is also connected to the processor 14. The processor 14 controls the operation of the computing system 10, receiving user inputs from the user interface 16 and controlling the output of the display device 12. A computer program product on a computer readable medium 18, such as a CD-ROM, can be used to operate the processor 14.

The computing system 10 shown in FIG. 1 is a conventional desktop computer that a user can utilize for standard desktop applications such as word processing, spreadsheets, Internet browsing, email and so forth. The processor 14 runs an operating system that provides the base for supporting one or more applications that provide the functions that the user needs. The operating system and all of the applications provide their interaction with the user through a graphical user interface that is shown on the display device 12. The processor 14, through the operating system, displays the graphical user interface on the display device 12, with which the user can interact.

The graphical user interface provides the user with access to the applications being run by the computing system 10. When the user is using an application, such as a word processing application, a text editor or a development environment, then the graphical user interface will display a document that comprises continuous text, which the user can amend, for example. The user can select text within the displayed document in such a manner that non-continuous text within the document can be selected. A tool may be run, for example as an add-on within the current application, which gives the user greater flexibility in how they can select and manipulate text in the document in accordance with the illustrative embodiments set forth herein.

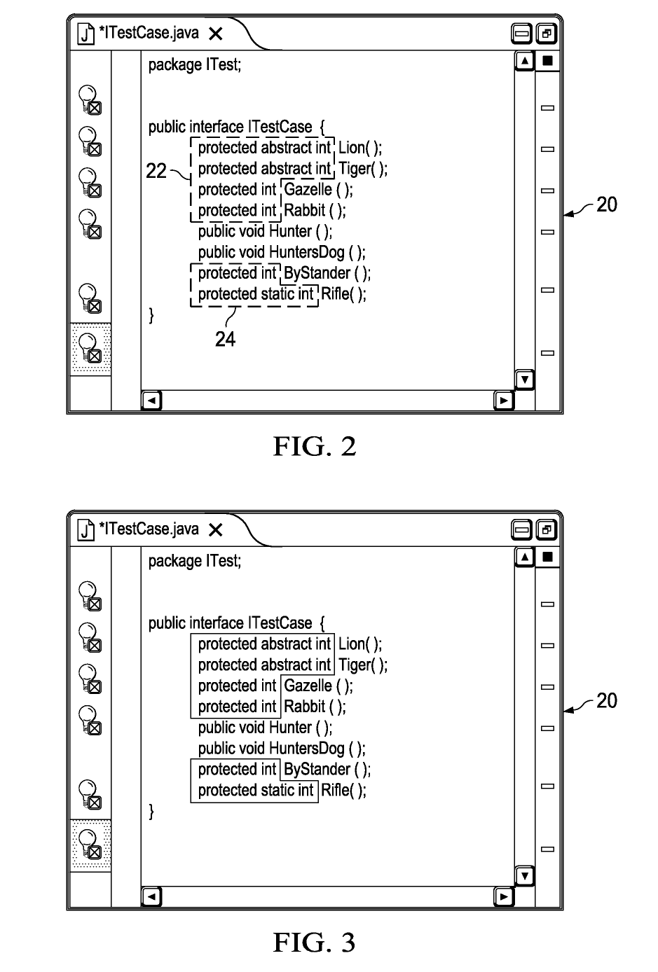

In one illustrative embodiment, this tool works in the following way. When the user runs the tool, the tool fetches information on the currently active application window. If the currently active application is one of the applications with which the tool works, then the tool fetches basic information about that application such as the position of the window, the window size, and the current screen resolution. The tool can be implemented by getting the window handle to the active window either through Java JNA, AutoIt, or other known languages. The tool then creates an in-memory representation of the active window and fetches all the information contained within the original window. FIG. 2 shows a screenshot of an active window 20.

If the original application is a text editor, then the tool fetches all the text from the window. On the other hand, if the application is a browser, then the tool obtains text, media, html tags and Cascading Style Sheets (CSS) that are either referenced or used in the displayed html document. The tool then populates the in-memory representation of the window with data that was fetched from the original window and reproduces the original formatting. The tool creates a snapshot of the original screen and compares the representation of the window with the original window by performing an intersect operation between the layer and the window to see if the contents align. The tool will keep modifying the formatting in the in-memory representation until the contents align.

The tool calculates the coordinates of data on the screen and cross-references the coordinates with data in the original window. The usage of an in-memory representation with referenced coordinates to the original data also allows the tool to calculate values such as the distance from the edge of the window, distance between words, lines, paragraphs and images, etc., which in turn allows the tool to preserve original formatting when copy/pasting data. The tool essentially creates a copy of displayed document, maintaining, as far as possible, the content and formatting of the text and objects that make up the displayed document. The user is then able to make selections of text (and optionally objects as well) within the tool.

When the user presses a pre-defined button, such as the ctrl key on the keyboard 16, the tool starts listening for mouse clicks. The x and y coordinates of each of the user's mouse clicks are stored as points. Upon the first mouse click, lines are established between points in the graphical user interface to indicate to the user the progress of their current selection. An area is considered defined when the last location clicked matches, or is within, a certain x, y threshold of the first location clicked. In FIG. 2, the area 22 has been defined by the user, which covers text in the document that is non-continuous.

If the special key is pressed again, the tool allows the user to create additional selection areas on the screen. For example, in FIG. 2, the user has also created area 24 as a selection of further text in the displayed document. Again, the area 24 is non-rectangular and is essentially a simple non-regular polygon composed of straight lines joining user defined points. The tool checks which data the chosen coordinate array refers to in the original window. If an image is within the selection shape, it is selected. If the selection partially overlaps an image or a letter, then the tool selects it. The original data can then be either copied to a buffer or replaced with different data.

FIG. 3 shows the same screenshot 20 of FIG. 2, but with the selected text highlighted, after the user has completed the bespoke selection. FIG. 4 shows how the document would look after replacing each line of text with “public void” and FIG. 5 shows how the selected text would look after being copied and pasted into a new document. The user is thus able to access text that would not normally be easily selectable in a conventional “start and end point” selection, which can only select continuous text. It is very useful in certain applications to be able to select non-continuous text, such as the example of FIG. 2, where the start of consecutive lines have been selected in one action.

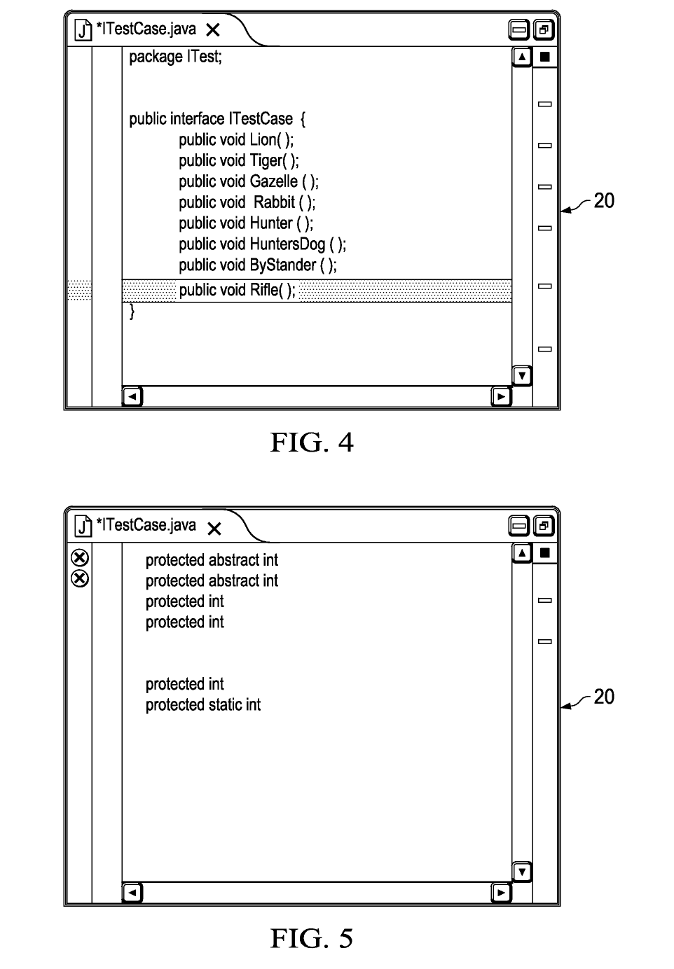

FIG. 6 is a flowchart outlining an operation for selecting text within a displayed document in accordance with one illustrative embodiment. The operation comprises, firstly step S6.1 for displaying a document which comprises continuous text and secondly, step S6.2, which comprises receiving user input defining a single continuous area of the displayed document, the defined area covering text within the displayed document that is non-continuous. Finally, the operation comprises step S6.3 which comprises capturing the text within the defined area. Objects such as pictures can also be captured at the same time as the text. The selected elements of the displayed document can then be manipulated as desired, for example deleting the elements, applying global changes such as underlining etc.

The illustrative embodiments provide a separate tool that captures the current displayed document and allows the user to work on this copy of the displayed document. However, it is also possible to provide the improved selection mechanisms directly within an application, with the additional functionality being provided directly from the normal graphical user interface to the application. In this case, the user could use the mouse to either scan a portion of the displayed document to define the area that is to be captured or could use mouse clicks to define the points of the area, which allows the user to define any polygon they wish, with straight lines joining points defined.

As can be seen in FIGS. 2 and 3, the user can select multiple areas 22 and 24 using the tool. The user can select as many areas as they wish and all can be generated using the same methodology that essentially allows the user to generate a polygon of their own choosing. Once the user finishes selecting areas, then the view of FIG. 3 will be shown to the user, highlighting the selected areas. The user can then perform specific commands that will apply to all of the highlighted areas. So for example, a replace command can be used that will be executed over all highlighted areas.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method, in a data processing system comprising a processor and memory, of selecting text within a displayed document, the method comprising the steps of:
displaying, on a display device associated with the data processing system, a document comprising continuous text;
receiving, via a user interface of the data processing system, user input defining a first area of the displayed document, the defined first area covering text within the displayed document that is non-continuous;
capturing, by the text within the defined first area; and
modifying, by the data processing system, the displayed document based on the capturing of the text within the defined first area.

2. A method according to claim 1, wherein the defined first area of the displayed document is non-rectangular.

3. A method according to claim 1, wherein the defined first area of the displayed document is an irregular polygon.

4. A method according to claim 3, wherein the received user input comprises locations of points of the irregular polygon.

5. A method according to claim 1, further comprising receiving further user input defining a second area of the displayed document, the defined second area covering text within the displayed document that is non-continuous with the first area, and capturing the text within the defined second area.

6. A system for selecting text within a displayed document, the system comprising a display device, a memory, a user interface, and a processor configured to:
display, on the display device, a document comprising continuous text;
receive, via the user interface, user input defining a first area of the displayed document, the defined first area covering text within the displayed document that is non-continuous;
capture the text within the defined first area; and
modify the displayed document based on the capturing of the text within the defined first area.

7. A system according to claim 6, wherein the defined first area of the displayed document is non-rectangular.

8. A system according to claim 6, wherein the defined first area of the displayed document is an irregular polygon.

9. A system according to claim 8, wherein the received user input comprises locations of points of the irregular polygon.

10. A system according to claim 6, wherein the processor is further configured to receive further user input defining a second area of the displayed document, the defined second area covering text within the displayed document that is non-continuous with the first area, and capture the text within the defined second area.

11. A computer program product on a non-transitory computer readable medium for selecting text within a displayed document, the product comprising instructions for:
displaying a document comprising continuous text;
receiving user input defining a first area of the displayed document, the defined first area covering text within the displayed document that is non-continuous;
capturing the text within the defined first area; and
modifying the displayed document based on the capturing of the text within the defined first area.

12. A computer program product according to claim 11, wherein the defined first area of the displayed document is non-rectangular.

13. A computer program product according to claim 11, wherein the defined first area of the displayed document is an irregular polygon.

14. A computer program product according to claim 13, wherein the received user input comprises locations of points of the irregular polygon.

15. A computer program product according to claim 11, further comprising instructions for receiving further user input defining a second area of the displayed document, the defined second area covering text within the displayed document that is non-continuous with regard to the first area, and capturing the text within the defined second area.

16. The method according to claim 1, wherein modifying, by the data processing system, the displayed document based on the capturing of the text within the defined first area comprises pasting the first area into the document with an original formatting of the first area.

17. The method according to claim 5, wherein modifying, by the data processing system, the displayed document based on the capturing of the text within the defined first area comprises pasting the first area and second area into a selected portion of the document in accordance with an order in which the first area and the selected area was selected.

18. The method according to claim 5, wherein modifying, by the data processing system, the displayed document based on the capturing of the text within the defined first area comprises pasting the first area and second area into a selected portion of the document in accordance with a relative display location of the first area and second area.

19. The system according to claim 10, wherein the processor is configured to modify the displayed document based on the capturing of the text within the defined first area at least by pasting the first area and second area into a selected portion of the document in accordance with an order in which the first area and the selected area was selected.

20. The system according to claim 10, wherein the processor is configured to modify the displayed document based on the capturing of the text within the defined first area at least by pasting the first area and second area into a selected portion of the document in accordance with a relative display location of the first area and second area.
